(19) United States
(12) Patent Application Publication
(10) Pub. No.: US 2026/0039946 A1
(43) Pub. Date: Feb. 5, 2026

(54) REAL-TIME FEEDBACK OF OBJECTS CAPTURED DURING AN IMAGE CAPTURE PROCESS

(71) Applicant: CANON KABUSHIKI KAISHA, Tokyo (JP)

(72) Inventors: Floyd Albert Maseda, Tustin, CA (US); Bradley Scott Denney, Irvine, CA (US); Xiwu Cao, Irvine, CA (US)

(21) Appl. No.: 19/100,067

(22) PCT Filed: Aug. 1, 2023
(86) PCT No.: PCT/US2023/071428

§ 371 Date: Jan. 30, 2025

Related U.S. Application Data
(60) Provisional application No. 63/394,442, filed on Aug. 2, 2022.

(51) Int. Cl. H04N 23/63; H04N 23/60; H04N 23/611

(52) U.S. Cl. CPC H04N 23/632; H04N 23/611; H04N 23/64

(57) ABSTRACT

A method and information processing apparatus for providing feedback during an image capture process is provided and includes displaying, on a display device, a first image capture region including a plurality of cells that identify an area of an image being captured by an image capture apparatus, determining an orientation of an object in the image being captured, displaying, on the display device and within the image capture region, an orientation indicator representing the determined orientation of the object, and continually updating the display of the first image capture region to indicate areas of the image capture region from which at least one image has been captured based on the movement of the orientation indicator as the orientation of the object in the image being captured is moved.

### CROSS-REFERENCE TO RELATED APPLICATIONS

This PCT application claims priority from U.S. Provisional Patent Application Ser. No. 63/394,442 filed on Aug. 2, 2022, the entirety of which is incorporated herein by reference.

### BACKGROUND

### Field

The present disclosure relates generally to video image processing

### Description of Related Art

It is well known that users are able to make use of an image capture apparatus such as a camera, smartphone, video capture device, etc. to capture a series of images of the user's face. While this operates well in the macro-sense, there is difficulty when attempting to capture a series of images (e.g. a video) intended to be a comprehensive collection of images depicting various facial poses, eye gazes and other face characteristics. Conventional capture methods are unable to successfully capture all intended images containing these characteristics. An apparatus and method remedies the drawbacks discussed above.

### SUMMARY

[symbol] displaying, on a display device, a first image capture region including a plurality of cells that identify an area of an image being captured by an image capture apparatus, determining an orientation of an object in the image being captured, displaying, on the display device and within the image capture region, an orientation indicator representing the determined orientation of the object, and continually updating the display of the first image capture region to indicate areas of the image capture region from which at least one image has been captured based on the movement of the orientation indicator as the orientation of the object in the image being captured is moved.

In certain embodiments, the activity of continually updating further includes modifying one or more of the cells in the image capture by changing, in response to the movement of the orientation indicator, a visual state of each cell of the image capture region.

In another embodiment, the method and information processing apparatus further includes determining that a predetermined amount of the image capture region has been updated and displaying, on the display device, a second image capture region having a plurality of cells, wherein the plurality of cells in the second image capture region are smaller than the cells in the first image capture region.

Further embodiments include capturing images of the object at a first resolution when as the object is moving and the first image capture region is displayed; and capturing images of the object a second resolution higher than the first resolution when the object is moving and the second image capture region is display.

In another embodiment, the method and information processing apparatus further includes identifying one or more features of the object to be extracted from the image being captured, determining an orientation resolution of an image needed for extracting the identified one or more features, setting a size of the cells of the first image capture region dependent on the determined orientation resolution; and displaying the first image capture region having cells corresponding the set size.

Other embodiments include determining a size of the cells in the first image capture region based on a feature of the object to be extracted from the image being captured and displaying the first image capture region having cells of the determined size.

In another embodiments, a size of the cell in the first image capture region and feedback is provided feedback to a user controlling movement of the object to ensure that the image being captured remains within the first image capture area.

In a further embodiment, the first image capture region is a two dimensional spheroid shape and the cells are formed via intersecting lines running longitudinal direction corresponding to yaw of the object being captured and latitudinal direction corresponding to pitch of the object being captured.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIGS. 1A-1C illustrate representative user interfaces and their associated changes based on the execution of a feedback algorithm according to the present disclosure.

FIG. 2 is a flow diagram illustrating the processing performed by the feedback algorithm according to the present disclosure.

FIG. 3 is a flow diagram illustrating the processing performed by the feedback algorithm according to the present disclosure.

FIGS. 4A-4B is a flow diagram and associated GUI that illustrates the processing performed by the feedback algorithm according to the present disclosure.

FIG. 5 is a block diagram detailing the hardware components of an apparatus that executes the algorithm according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

The present disclosure describes an apparatus and method that improves the processing associated with capturing a series of images, either a plurality of sequential still images or video image data. Often times it is desirous to capture a comprehensive collection of images that contain a plurality of different visual characteristics of the object being captured. To ensure the image capture process is completed with enough images having different views of the object such that a plurality of object characteristics are identified and can be used in further processing, the present disclosure advantageously provides real-time directed feedback during the image capture process thereby ensuring a complete acquisition of image data with all necessary views and angles to readily identify one or more characteristics of the object. This is provided by an application executing on an information processing apparatus that includes an image capture device such that the information processing apparatus is controlled to display an image being captured, in real-time, by the image capture device and one or more overlays representing a coverage area of an object being displayed on the display thereof. This advantageously directs a user to modify a capturing view such that different angles, positions and orientations of the object can be captured while providing visual feedback within the user interface that indicates, to the user, that the different angles, positions and orientations of the object have been captured.

In one embodiment, the object being captured is a face of a user and the one or more characteristics being identified or otherwise recognized from the captured image include, but are not limited to, any of face orientation, head orientation, eye gaze, or any orientation of any facial feature. This image capture processing poses particular difficulty due to the nature of the human face and the multitude of expressions able to be expressed. In order to obtain a robust and complete set of images to identify and make use of facial feature data in further image processing applications, providing real-time directive feedback to a user during the image capturing process which causes an image capture device to operate in a reactive manner so that an image capture guide being displayed on a display of the image capture device is directly responsive to the user's movement. This responsiveness results in dynamic, real-time updates to user interface display images being displayed during the image capture process. This has the further advantage of making sure that the images being captured provide the level of detail sufficient to obtain one or more facial features or characteristics therefrom.

According to the present disclosure, an information processing apparatus generates one or more graphical user interfaces that provide feedback to a user during an image capture process. The user interface includes at least one region that is displayed over an image being captured in real time. As the object in the image being captured is moved, a state of the user interface and image capture region is changed thereby indicating that object is successfully captured at that particular angular orientation. The state of the image capture region is changed indicating that the images captured represent orientations covering at least a predetermined amount of the image capture. At this time, depending on what the captured image data will be used for, a second image capture region may be displayed which enables capturing of the orientation of the object at a higher angular resolution. The user interface provides real-time feedback representing a first orientation of the object in the image being captured and displays this orientation indicator that allows the user controlling the movement of the object to see just how much of the image capture region is captured as the object is being moved. The user interface provides additional feedback to the user, in real time, in the form of visual indicators and/or icons being displayed in the user interface along with the image capture region and progress of the image being captured to guide the user to control the movement of the object to ensure a full set of images are captured and that those captured images are of sufficient quality and angular resolution so that they may be used for further image processing. In one embodiment, the further image processing may be using these images as pre-captured images for an image section replacement process such as replacing images in a virtual reality space.

The following contains a description of a feedback application that is executing on an information processing apparatus such as a mobile phone, tablet or other computing device. The feedback application includes one or more algorithms embodied as a set of instructions that, when executed by one or more processing devices, control an information processing apparatus to provide the described functionality. In the following description, the feedback provided is for an image capture process where the object being captured is a face of a user. This is described for purposes of example only and other objects are able to be captured and feedback of the capture is provided in a similar manner based on the description and principles described herein.

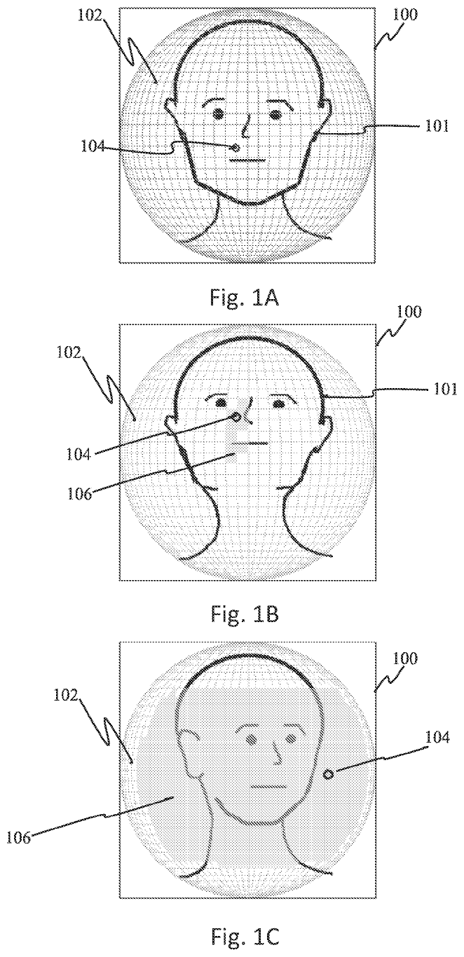

As shown in FIGS. 1A-1C, in order to provide the user with live feedback during an image capture process, a graphical user interface (GUI) 100 is displayed on the screen (for example, in a mobile phone application).

An image capture region 102 depicting all desired orientations of the object 101 being captured is provided. In one embodiment, this includes all facial orientations and/or eye gaze directions. The image capture region 102 includes a plurality of cells. The cells may be grouped into a grid of “bins” of adjustable size. In one exemplary embodiment, the image capture region 102 depiction is any two-dimensional projection of a sphere with bin edges formed by lines of “latitude” and “longitude” corresponding to angles of pitch (up/down) and yaw (right/left), respectively. This grid of longitudinal and latitudinal lines may be fixed on the screen with the user's face or eyes cropped into focus, or the grid may follow the user's head in the image as they move.

The GUI 100 further includes at least one orientation indicator 104. The orientation indicator 104 represents a graphical indication of the pose and position of the object being captured. In one embodiment, a position of the orientation indicator 104 represents a user's current facial pose or eye gaze that is being captured, in real-time, by the image capture device and which is superimposed onto the image capture region 102. In one embodiment, the orientation indicator 104 may be a dot which traverses the grid of the image capture region 102 as the user 101 moves their head and/or eyes through various orientations. In another embodiment, the orientation indicator 104 may be a line emanating, for example, from the user's nose or eyes and indicating in some way the current orientation on the grid.

The GUI 100 also displays a graphical indication of all “visited” orientations 106 the camera has captured up to the current point in time. In one embodiment, the image capture region 102 is continually updated by adding a semi-transparent overlay (shown herein a solid gray shading which is positioned atop the grid of the image capture region 102) on top of the grid that highlights (or otherwise identifies) the visited bins 106. In one embodiment, this indication may be performed by using various colors, opacities, or other indicators depending on the quality or quantity of captured images in that bin.

The above described GUI 100 is shown in FIGS. 1A-1C and a description as to how the feedback application receives information and causes the change in the GUI display in response thereto will now be provided. FIG. 1A represents an initial state whereby an image capture device of an information processing apparatus is capturing an image of an object 101 (e.g. a human face). In this initial state, the orientation indicator 104 is also caused to be displayed within the GUI 100 and represents a current orientation of the object 101 being captured. The orientation indicator 104 may trace a line from a particular orientation point on the object 101 being captured. In the embodiment shown herein, the object being captured is a human face and the orientation point are the eyes of the human face such that the orientation indicator 104 represents the position and orientation of the gaze of the eyes of the captured human face. An image capture region 102 is illustrated as a spheroid grid and represents orientation(s) and position(s) of the object 101 desired to be captured and obtained. Once the orientation point of the object 101 begins to change, the feedback application captures successive images and, as the orientation point of the object 101 changes, the orientation indicator 104 moves within the GUI 100 and its position is currently updated to correspond to the orientation point on the object. Further, as shown in FIG. 1B, the image capture region 102 is changed to display visited regions 106. During the image capture process, the feedback application determines whether sufficient image data representing the particular position and orientation of the object has been captured, and in response to determining that sufficient image data is captured, the feedback application controls the GUI to display visited regions 106 within the image capture region 102. The determination processing will be described hereinbelow. Continuing to FIG. 1C, the object has changed its position and orientation and the GUI 100 illustrates that a large area of the image capture region 102 has been visited.

In other embodiments, the GUI may include one or more of the following functions thereby enhancing the quality of the image being captured by providing real-time dynamic feedback to the user. In response to user movement, the GUI 100 is dynamically modified to provide the user with additional feedback. The additional features include, but are not limited to one or more textual or graphical indications within the GUI 100 screen describing the total coverage captured from the initiation of the image capture process until a current time. This may take the form of a percentage of desired or required bins of the displayed image capture region 102. In certain embodiments, based on the purpose or type of image being captured, including an angular resolution at which the images are being captured, a total coverage indicator may be different.

In another embodiment, the image capture region 102 includes a modification to the grid highlighting or indicating cells which the application deems as desired or required for a particular image capture purpose. In one embodiment, the GUI may include a “border” in the grid indicating the range of (yaw/pitch for example) angles desired or required for capture. For example, if the user is performing an initial capture and is required to cover the entirety of a range of yaw/pitch angles, the border would indicate the boundaries of the range. Another embodiment may indicate specific, possibly discontiguous, orientations desired or required for capture. For example, if a user has previously completed the image capture process to degree deemed insufficient and elects or is required to repeat the process to fill in any gaps in coverage, the image capture region 102 may only consist of grid cells corresponding to the uncaptured orientations in the original capture.

The GUI may include one or more interactive GUI elements that allow the user to control what is being displayed at a given time in the GUI. For example, a button or region of the screen which allows the user to end capture; a toggle switch to enable a stationary or moving grid; a dropdown, slider, or other selector to change the spherical projection and/or grid size; etc.

In a further embodiment, the GUI includes a defined region where the user's head or face should be placed. For example, a box, circle, or other shape in the center of the GUI may indicate that the user's face should fall within that shape. In this embodiment, the shape may be dynamically changed in response to movement or detection of the user's face such as changing a color of the shape and/or causing the image capture device to issue a visual, physical. or audible output as feedback to prompt the user to reposition their face within the shape. In certain of these embodiments, the image capture application that controls the image capture process may be provided with information indicating the position/orientation of the user at a given time and, if not within the shape, may control the image capture application to not count certain head poses or eye gazes as valid (as described herein below) when the head or face is outside the designated shape.

In another embodiment, the feedback processing application that generates the GUI described above, may cause the information processing apparatus (e.g. mobile phone) to issue an audible, vibration, or other feedback to allow the user to focus on maintaining a valid eye gaze with the image capture device (e.g. camera) rather than having to look at the screen. For example, when the user turns to very large angles and face detection fails, a sound may be played, or the device may vibrate to alert the user that they are no longer providing useful capture.

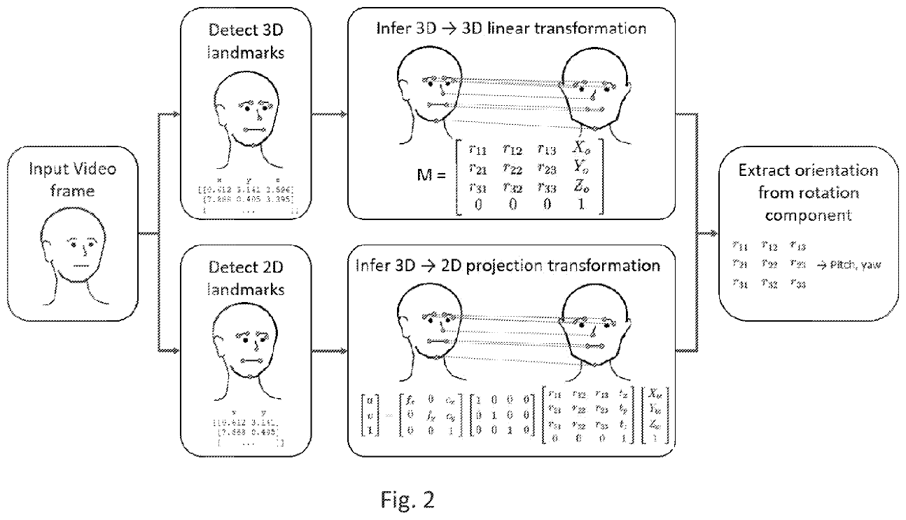

The process of detecting the facial position and orientation used by the feedback application to provide the desired feedback will now be discussed with respect to FIG. 2. The method by which the user's current face pose is detected, e.g., for use in GUI described above uses a method of detecting facial pose in an image by detecting a number of 2D or 3D facial landmarks, e.g., eyes, nose, corner of mouth, cheeks, chin, etc. These facial landmarks are then compared with a standard 3D model of a human face to determine the user's current orientation. In the case where the detected facial landmarks are imbued with depth information making them 3D, the current orientation may be determined through means of finding a (sequence of) linear transformation(s) consisting of a rotation, a translation, and possibly a scale factor to align the coordinates of the detected landmarks with those of the corresponding points in the standard 3D model. This linear transformation can then be decomposed into its constituent parts, and the pitch and yaw orientation angles can be extracted from the rotation component. If the detected facial landmarks lack depth information so are only 2D, one possible method of inferring pose information is to solve a perspective-n-point (PnP) problem, wherein, in addition to the rotation, translation, and scaling between corresponding 3D points, a further perspective projection from 3D to 2D is inferred. The transformation is again decomposed into constituent parts, and the pitch and yaw orientation angles are extracted from the rotation component.

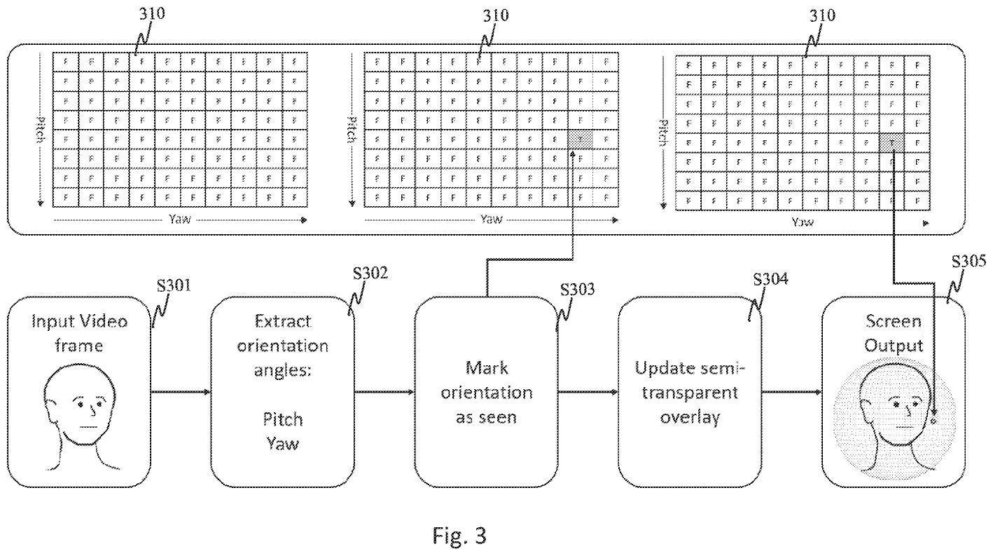

The following will describe the processing performed by the feedback application to identify and record the visited orientations during the image capture process used to control the updating of the GUI thereby providing feedback to the user during the image capture process. More specifically, this processing which is illustrated in FIG. 3, describes the logic used to determine when to change individual sections/cells/positions within the image capture region 102 into visited regions 106.

During the capture process, the image capture device of the information processing apparatus, captures a series of images in S301 and, from those captured images, a record of all visited orientations of the object is obtained in S302. The orientations are identified using the algorithm described in FIG. 2 whereby the orientation angles corresponding to the orientation point on the captured object are extracted such that pitch and yaw information is determined. When values corresponding the orientation angles are obtained, those values are stored and are used to update an orientation data structure 310 stored in memory. The orientation data structure 310 is stored in memory and includes information identifying the orientations that have been captured up to a current time. From the determined orientation angle information, the feedback application causes a value in the orientation data store 310 to change from a first value (e.g. False) to a second value (e.g. True) indicating that a particular cell/bin in the image capture region 102 (FIG. 1A) includes the extracted orientation information. In one embodiment, the data structure is a Boolean array, which is used and referenced by a GUI generator when updating the semi-transparent overlay representing the areas that have been covered. All cells corresponding to previously captured orientations may be set to True or False while cells corresponding to non-captured orientations contain the opposite label. As the image capture process is performed in S301, based on the orientation information determined above, the feedback application extracts orientation information in S302, such as pitch and yaw, at a given time corresponding to one or more cells in the image capture region 102. The data structure 310 is updated in S303 to change a value therein in memory to indicate that information from the image corresponding to a particular cell in the image capture region has been successfully captured. The GUI generator references the data structure, it uses the information contained therein to update sections of the image capture region that are identified in the data structure as captured. The update includes, modifying the display in such a manner to visually indicate that a particular area of the image capture region has been covered and the image thereof has been captured.

In another embodiment, this data may be stored as an integer or floating point array, where each element contains a number corresponding to how many times the user has visited this cell or a quality measure of the captured images in that cell. These numbers may then be tied to a color map, opacity level, or other stratified indicator to be used in the continual modification of the image capture region, such as the semi-transparent overlay described above.

In an embodiment where the image capture region is not depicted as a grid, or if the bin size is so small as to make a single array representing all orientations infeasible to store in memory, other data structures may be implemented. For example, it may be more memory efficient to use a dictionary or hash map with keys corresponding to each cell, and only including a cell's key after that cell has been visited. In particular, if the image capture region only consists of a small fraction of cells in the grid, this storage method would only require enough memory for the small fraction of cells in the capture region rather than having to allocate memory for the entirety of the grid. Regardless of the storage method, in each frame the transparent overlay may be updated or completely redrawn according to the contents of the storage.

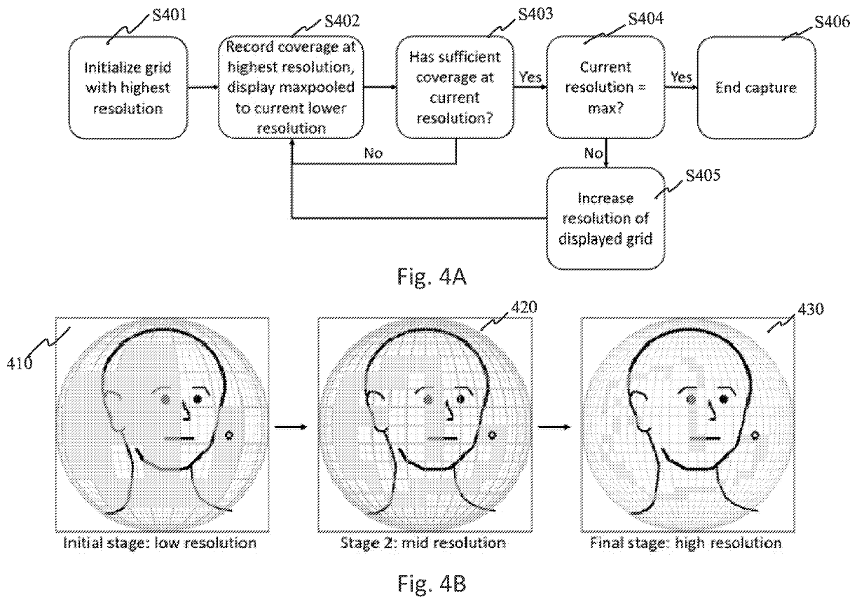

In another embodiment, the feedback application includes a multiscale user interface that provides feedback during an image capture process at multiple image capture resolutions. This is shown in FIGS. 4A & 4B.

In certain embodiments, the image capture process may require the images to be captured multiple times at different grid resolutions based on the purpose for which the captured images will be used. Some embodiments guide the user through a low resolution grid first of a first predetermined size and, at completion thereof, cause display of a second higher resolution grid of a second predetermined size. This processing is performed in accordance with the algorithmic flow of FIG. 4A. In S401, the feedback application initializes the GUI to include an image capture region at a first resolution (410 in FIG. 4B) whereby the grid that forms the image capture region has less total cells in a grid area. From there, image capture processing is performed in S402 as described herein above with respects to FIGS. 1-3 to capture the orientation of the object (e.g. human face) at that first resolution. In S403 a determination is made to determine whether sufficient amount of orientation and position information can be derived from the images being captured at the first resolution. If not enough coverage is captured, the algorithm reverts back to S402 to direct the user to change the position and orientation of the object (e.g. human face) to obtain additional orientation information at the first resolution. If the determination in S403 is positive indicating that sufficient coverage representing position and orientation of the object has been captured, a further determination regarding the capture resolution of the image capture region is made in S404. In S404, it is determined whether the current capture resolution of the image capture region is the maximum image capture resolution. If the result of the determination in S404 is negative indicating that higher resolution image capture regions are available, in S405, the image capture resolution is increased resulting in the number of cells in the grid being larger in size but smaller in number (see 420 and/or 430 in FIG. 4B). If the determination in S404 is positive indicating that the most recent image capture processing occurred using the highest image capture region resolution (e.g. 430 in FIG. 4B), the image capture processing is ended in S406.

In one example, as shown in FIG. 4B, the first low resolution grid may be a 4 by 4 grid and the user is directed to move their head or eyes to cover the 16 cells in the 4 by 4 grid. Once complete, the user can then be directed to a grid of the next scale which is the second higher resolution grid of a second predetermined size. In one example, the second higher resolution grid is a 12 by 12 grid wherein each cell in the 4 by 4 grid is now comprised of its own 3 by 3 grid. When moving to this next scale, the occupancy of the 12 by 12 grid shows the cells that were hit by the initial head or eye motion from the lower scale pass. In this case, even when operating with the lower scale grid, the head or eye orientation is recorded at a higher resolution and the lower scale grid shows the orientations achieved in aggregate. This approach ensures that broad and diverse coverage of the grid is achieved first before focusing on the next scale. This allows for the data collection to be gathered in a way that becomes progressively denser while still remaining diverse. More specifically, the multiscale approach is advantageous because, if image capture processing is performed at a low resolution first, we obtain images from a diverse range of orientations quickly (e.g. at least one image where the user is looking left/right/up/down rather than having four images of them looking different degrees of left but none where they're looking right). Thereafter, obtaining images at a higher resolutions fill in the gaps for progressively denser coverage while maintaining diversity. Two or more scales can be requested in this manner. Some embodiments let the user determine how many scales they wish to achieve. In these embodiments feedback to the user on the quality of the scan may be provided so the user has an expectation of the types of results they can expect to achieve by reaching a given level of scale.

The feedback application may also perform processing to provide feedback of not only a primary image capture process whereby the user moves their head in different orientations, but also provide feedback for secondary action processing. As used herein, secondary action processing includes performing at least one further action or task during the image capture process. This processing occurs in the context of capturing various orientations wherein the user must perform a secondary action consisting of a specific task, for example, making a specific facial expression, opening/closing their eyes, etc. For these embodiments, in addition to detecting the orientation of the user's face, it may also be necessary to employ feature detection algorithms such as eye gaze, blink, or facial action unit (FAU) detection that make use of at least some of the same facial landmarks used to detect facial orientation. This secondary detection may then inform the continual update of the image capture region whereby the GUI is updated with a secondary completion indicator that causes only the cells visited to be modified (e.g. colored) if the feedback application determines that the user performed the specific action at the same time their head was oriented at that particular angle. In other embodiments, the GUI provides an indicator that alerts the user to a reason why a particular cell or group of cells in the image capture region were not updated or modified. In so doing, the application provides real-time feedback to the user that one or more of the primary or secondary actions was not properly performed and recorded as discussed above. Depending on the nature of the task to be performed, the image capture region may be selectively toggled to only capture at the first, lower resolution to achieve sufficient coverage. In this embodiment, a single Boolean array may still be used as the data structure but cells in the array are only updated to “True” if all primary and all secondary actions were performed. However, if it is detected by the algorithm that the primary action (e.g. moved to a particular orientation) has been performed but the second action (e.g. perform a predetermined facial expression) has not been performed, the cell remains marked as “False”, in other words, the particular cell in the array is not actively marked “True”.

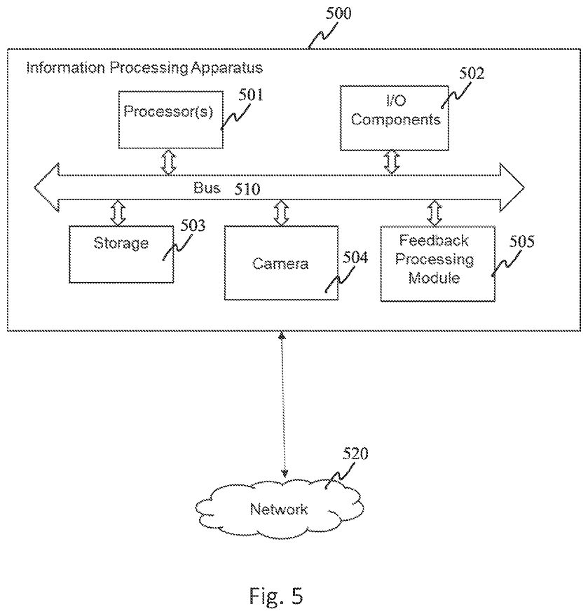

FIG. 5 illustrates the hardware of the information processing apparatus 500 which is selectively connected to a network 520 such as a wired network, a wireless network, a LAN, a WAN, a MAN, and a PAN. Also, in some embodiments the devices communicate via other wired or wireless channels.

The information processing apparatus 500 includes one or more processors 502, one or more I/O components 502, and storage 503. Also, the hardware components communicate via one or more buses 510 or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 501 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 502 include communication components such as a network interface and a display for displaying a plurality of graphical user interfaces The network and other input or output devices 502 (not illustrated), may include a keyboard, a mouse, a printing device, a touch screen, a light pen, an optical-storage device, a scanner, a microphone, a drive, and a game controller (e.g., a joystick, a gamepad).

The storage 503 includes one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 503, which may include both ROM and RAM, can store computer-readable data or computer-executable instructions.

The information processing apparatus, as shown herein, includes a camera 504 and all associated hardware and software that controls the image capture processing. The image data captured includes both still image data and video image data. The captured image data is stored in the storage 503 and can be made accessible to any other components of the information processing apparatus.

The information processing apparatus includes a feedback processing module 505 that performs the functions described hereinabove with respect to FIGS. 1-4. A module includes logic, computer-readable data, or computer-executable instructions. In the embodiment shown in FIG. 5, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

The scope of the present disclosure includes a non-transitory computer-readable medium storing instructions that, when executed by one or more processors, cause the one or more processors to perform one or more embodiments of the invention described herein. Examples of a computer-readable medium include a hard disk, a floppy disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

The use of the terms “a” and “an” and “the” and similar referents in the context of this disclosure describing one or more aspects of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter disclosed herein and does not pose a limitation on the scope of any invention derived from the disclosure unless otherwise claimed. No language in the specification should be construed as indicating any non-claimed element as essential.

It will be appreciated that the instant disclosure can be incorporated in the form of a variety of embodiments, only a few of which are disclosed herein. Variations of those embodiments may become apparent to those of ordinary skill in the art upon reading the foregoing description. Accordingly, this disclosure and any invention derived therefrom includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of providing feedback during an image capture process, the method comprising:
displaying, on a display device, a first image capture region including a plurality of cells that identify an area of an image being captured by an image capture apparatus;
determining an orientation of an object in the image being captured;
displaying, on the display device and within the image capture region, an orientation indicator representing the determined orientation of the object;
continually updating the display of the first image capture region to indicate areas of the image capture region from which at least one image has been captured based on the movement of the orientation indicator as the orientation of the object in the image being captured is moved.

2. The method according to claim 1, wherein the activity of continually updating further comprises:
modifying one or more of the cells in the image capture by changing, in response to the movement of the orientation indicator, a visual state of each cell of the image capture region.

3. The method according to claim 1, wherein the cells of the image capture region enable image capture at a first resolution.

4. The method according to claim 1, further comprising:
determining that a predetermined amount of the image capture region has been updated;
displaying, on the display device, a second image capture region having a plurality of cells, wherein the plurality of cells in the second image capture region are smaller than the cells in the first image capture region.

5. The method according to claim 4, further comprising
capturing images of the object at a first resolution when as the object is moving and the first image capture region is displayed; and
capturing images of the object a second resolution higher than the first resolution when the object is moving and the second image capture region is display.

6. The method according to claim 1, further comprising:
identifying one or more features of the object to be extracted from the image being captured;
determining an orientation resolution of an image needed for extracting the identified one or more features;
setting a size of the cells of the first image capture region dependent on the determined orientation resolution; and
displaying the first image capture region having cells corresponding the set size.

7. The method according to claim 1, further comprising:
determining a size of the cells in the first image capture region based on a feature of the object to be extracted from the image being captured; and
displaying the first image capture region having cells of the determined size.

8. The method according to claim 1, wherein a size of the cell in the first image capture region corresponds to an orientation resolution at which the image of the object is captured.

9. The method according to claim 1, further comprising
providing feedback to a user controlling movement of the object to ensure that the image being captured remains within the first image capture area.

10. The method according to claim 1, wherein the first image capture region is a two dimensional spheroid shape and the cells are formed via intersecting lines running longitudinal direction corresponding to yaw of the object being captured and latitudinal direction corresponding to pitch of the object being captured.

11. An information processing apparatus comprising:
a display device;
at least one memory storing instructions;
at least one processor that, upon execution of the stored instructions, is configured generate an first image capture region including a plurality of cells that identify an area of an image being captured by an image capture apparatus for display on the display device;
determine an orientation of an object in the image being captured;
display, on the display device and within the image capture region, an orientation indicator representing the determined orientation of the object;
continually update the display of the first image capture region to indicate areas of the image capture region from which at least one image has been captured based on the movement of the orientation indicator as the orientation of the object in the image being captured is moved.

12. The information processing apparatus according to claim 11, wherein execution of the instructions further configures the at least one processor to:
modify one or more of the cells in the image capture by changing, in response to the movement of the orientation indicator, a visual state of each cell of the image capture region.

13. The information processing apparatus according to claim 11, wherein the cells of the image capture region enable image capture at a first resolution.

14. The information processing apparatus according to claim 11, wherein execution of the instructions further configures the at least one processor to:
determine that a predetermined amount of the image capture region has been updated;
display, on the display device, a second image capture region having a plurality of cells, wherein the plurality of cells in the second image capture region are smaller than the cells in the first image capture region.

15. The information processing apparatus according to claim 14, wherein execution of the instructions further configures the at least one processor to:
capture images of the object at a first resolution when as the object is moving and the first image capture region is displayed; and
capture images of the object a second resolution higher than the first resolution when the object is moving and the second image capture region is display.

16. The information processing apparatus according to claim 11, wherein execution of the instructions further configures the at least one processor to:
identify one or more features of the object to be extracted from the image being captured;
determine an orientation resolution of an image needed for extracting the identified one or more features;
set a size of the cells of the first image capture region dependent on the determined orientation resolution; and
display the first image capture region having cells corresponding the set size.

17. The information processing apparatus according to claim 11, wherein execution of the instructions further configures the at least one processor to:
determine a size of the cells in the first image capture region based on a feature of the object to be extracted from the image being captured; and
display the first image capture region having cells of the determined size.

18. The information processing apparatus according to claim 11, wherein a size of the cell in the first image capture region corresponds to an orientation resolution at which the image of the object is captured.

19. The information processing apparatus according to claim 11, wherein execution of the instructions further configures the at least one processor to:
provide feedback to a user controlling movement of the object to ensure that the image being captured remains within the first image capture area.

20. The information processing apparatus according to claim 11, wherein the first image capture region is a two dimensional spheroid shape and the cells are formed via intersecting lines running longitudinal direction corresponding to yaw of the object being captured and latitudinal direction corresponding to pitch of the object being captured.
